(19) United States
(12) Patent Application Publication
(10) Pub. No.: US 2025/0078164 A1
(43) Pub. Date: Mar. 6, 2025

(54) SYSTEMS AND METHODS FOR RENORMALIZATION OF DATA DRIVING FINANCIAL VALUATION

(71) Applicant: Credit Spectrum, Corp., Phoenix, AZ (US)

(72) Inventors: Sylvain R. Raynes, Phoenix, AZ (US); Ann E. Rutledge, Phoenix, AZ (US)

(21) Appl. No.: 18/464,764

(22) Filed: Sep. 11, 2023

Related U.S. Application Data
(60) Provisional application No. 63/535,830, filed on Aug. 31, 2023.

(51) Int. Cl. G06Q 40/08

(52) U.S. Cl. CPC G06Q 40/08

(57) ABSTRACT

A system is herein disclosed. The system comprises a processor and a memory. The memory stores instructions that cause the processor to: create a claim pool; receive a set of medical claims data from a database, each medical claims data comprising at least a claim identifier, a procedure code, and a claim date; validate the claim pool against one or more diversification criteria; validate the claim pool against one or more eligibility criteria; if the claim pool is valid, then incorporate the set of medical claims data into the claim pool and generate the security; if the claim pool is not valid, mark a portion of the set of medical claims data as orphaned if the set of medical claims data moves the claim pool further from validity, otherwise incorporate the set of medical claims data into the claim pool and return to receive the set of medical claims data.

### REFERENCE TO RELATED APPLICATIONS

The present patent application claims priority to the provisional patent application filed Aug. 31, 2023 and identified by U.S. Ser. No. 63/535,830, the entire contents of which are hereby expressly incorporated herein by reference.

### BACKGROUND OF THE INVENTION

The widespread sterility of current approaches to healthcare finance reform stems from the same underlying cause: the failure to conceive the problem as a whole, as a system.

Currently, a hospital, physician or other provider performs a service and submits a claim to a payer. In nearly 50% of cases the payer is the US government. The remaining 50% are paid by the insurers and, somewhat problematically, the patients. The billing process is performed with various degrees of efficiency by the provider's billing department or a third-party administrator (TPA) under contract.

Depending on the billing efficiency of the particular provider, the generation and submission of the bill can take anywhere from days to months from the date of service; reimbursement can take another 30 to 90 days. A percentage of claims will contain mistakes and/or inconsistent data that can cause the claim to be rejected or pended while the errors are corrected. The impact on cash flow is obvious. If the provider is not cash rich, it must borrow against expected future payments to create immediate cash flow. In most cases, this is an expensive process. Just how expensive it is, depends on the financial condition and credit rating of the provider and the particular financing mechanisms available to them.

Despite the size and quality of the insurer payment stream, lenders have historically assigned them little or no collateral value, due to the challenge of valuating medical claim receivables, the difficulty in monitoring the collateral, and the uncertainty around the enforceability of a perfected security interest in the collateral. For example, there may be a large variability in the reimbursement amounts for the same procedures and claims processing efficiency between providers. Additionally, traditional collateral management processes are overwhelmed by the volume, velocity, and granularity of medical claims, and the collateral pool, which can contain thousands of claims, continuously changes with the addition of new claim submissions and the removal of reimbursed claims.

Therefore, a need exists for systems and methods to orchestrate payment of the medical claim receivables, while managing the collateral pool in a fast and efficient manner.

### SUMMARY OF THE INVENTION

The problem of orchestrating the payment of medical claims while managing the collateral pool in a fast and efficient manner is solved by the systems and methods herein disclosed. The systems and methods include a system comprising a processor and a memory. The memory comprises a non-transitory processor-readable medium storing processor-executable instructions that when executed by the processor, causes the processor to: create a claim pool; receive a set of medical claims data from a database stored in the memory, each medical claim comprising at least a claim identifier, a procedure code, and a claim date; validate the claim pool against one or more diversification criteria; validate the claim pool against one or more eligibility criteria; if the claim pool is valid, then incorporate the set of medical claims data into the claim pool and generate the security; if the claim pool is not valid, mark at least a portion of the set of medical claims data as orphaned if the set of medical claims data moves the claim pool further from validity or incorporate the set of medical claims data into the claim pool if the set of medical claims data does not move the claim pool further from validity and return to receive the set of medical claims data.

In another embodiment, the systems and methods include a system comprising a processor and a memory. The memory comprises a non-transitory processor-readable medium storing processor-executable instructions that when executed by the processor, causes the processor to: receive sanitized claims data from a claims processor system, the sanitized claims data including one or more medical claims data corresponding to one or more medical claim and having a plurality of claim properties comprising at least a claim identifier, a procedure date, a procedure performed, a healthcare provider ID, a geographic area, and a claim date; augment the sanitized claims data to include a claim valuation for each of the one or more medical claims data based on the plurality of claim properties and to include one or more securitization parameters; create a claim pool comprising a provisional set of the one or more medical claims data; generate a lien request for each medical claim corresponding to the medical claims data in the claim pool; transmit the lien request to a State system corresponding to the geographic area; receive a sanitized explanation of benefits, the sanitized explanation of benefits including at least the healthcare provider ID, one or more claim identifier, and a payment amount for each claim identifier; and transmit a transfer request to a third-party banking system having a lockbox account corresponding to the healthcare provider ID, the transfer request being a request to transfer funds based on the payment amount for each claim identifier in the explanation of benefits.

Implementations of the above techniques include methods, apparatus, systems, and computer program products. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of hardware forming a valuation system constructed in accordance with the present disclosure.

FIG. 2 is a diagram of an exemplary embodiment of an orchestrator system constructed in accordance with the present disclosure.

FIG. 3 is a diagram of an exemplary embodiment of a user system for use with the system of FIG. 1 constructed in accordance with the present disclosure.

FIG. 4 is a functional block diagram of an exemplary embodiment of the orchestrator system constructed in accordance with the present disclosure.

FIG. 5 is a process diagram of an exemplary embodiment of a pool creation process constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable media may include a non-volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, combinations thereof, and/or the like.

Such non-transitory computer-readable media may be electrically based, optically based, magnetically based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

Referring now to the drawings, and in particular to FIG. 1, shown therein is a diagram of an exemplary embodiment of a valuation system 10 constructed in accordance with the present disclosure. The valuation system 10 may include an orchestrator system 14 in communication with an insurer system 18, a medical system 20, and a State system 22. The orchestrator system 14 may communicate with each of the insurer system 18, the medical system 20, and the State system 22 via a network 26.

In one embodiment, the valuation system 10 may further include a user system 28 in communication with one or more of the orchestrator system 14, the insurer system 18, the medical system 20, and the State system 22 via the network 26. A user may access an application via the user system 28 to interact with the orchestrator system 14.

In some embodiments, the network 26 may be the Internet and/or other network. For example, if the network 26 is the Internet, a user interface of the valuation system 10 may be delivered through a series of web pages or private internal web pages of a company or corporation, which may be written in hypertext markup language (HTML/PHP/JavaScript), for example, and may be accessible by the user system 28. It should be noted that the user interface of the valuation system 10 may be another type of interface including, but not limited to, a Windows-based application, a tablet-based application, a mobile web interface, an application running on a mobile device, a virtual-reality interface, an augmented-reality interface, and/or the like.

The network 26 may be almost any type of network. For example, in some embodiments, the network 26 may be a version of an Internet network (e.g., exist in a TCP/IP-based network). In one embodiment, the network 26 is the Internet. It should be noted, however, that the network 26 may be almost any type of network and may be implemented as the World Wide Web (or Internet), a local area network (LAN), a wide area network (WAN), an LPWAN, a LoRaWAN, a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices, operating separately or together. Additionally, or alternatively, one or more of the devices of the valuation system 10 may perform one or more functions described as being performed by another one or more of the devices of the valuation system 10. Devices of the valuation system 10 may interconnect via wired connections, wireless connections, or a combination thereof.

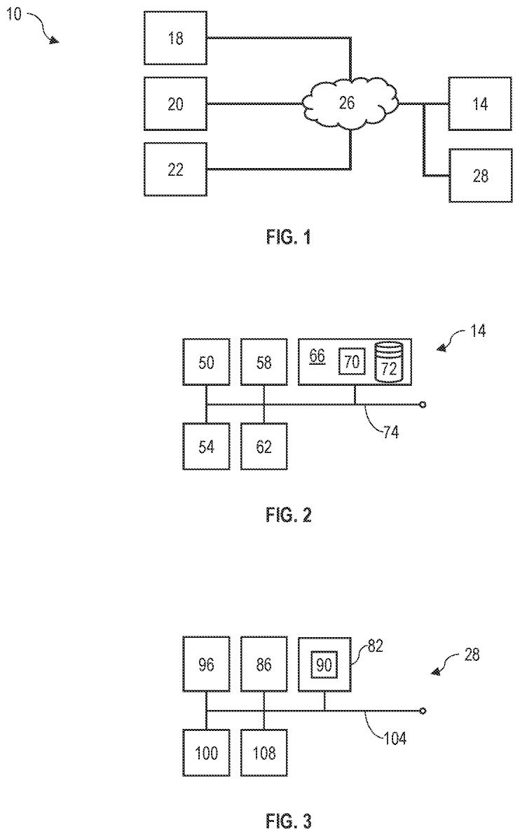

Referring now to FIG. 2, shown therein is a diagram of an exemplary embodiment of the orchestrator system 14 of the valuation system 10 constructed in accordance with the present disclosure. In some embodiments, the orchestrator system 14 may include, but is not limited to, implementations as a personal computer, a cellular telephone, a smart phone, a network-capable television set, a tablet, a laptop computer, a desktop computer, a server computer, a network-capable handheld device, and/or the like.

In some embodiments, the orchestrator system 14 may include one or more input device 50 (hereinafter “input device 50”), one or more output device 54 (hereinafter “output device 54”), one or more processor 58 (hereinafter “processor 58”), one or more communication device 62 (hereinafter “communication device 62”) capable of interfacing with the network 26, one or more memory 66 (hereinafter “memory 66”) storing processor-executable code and/or software application(s) 70 (hereinafter “application 70”) and one or more database 72 (hereinafter “database 72”). The application 70 may include, for example, a web browser capable of accessing a website and/or communicating information and/or data over a wireless or wired network (e.g., the network 26), and/or the like. The input device 50, output device 54, processor 58, communication device 62, and memory 66 may be connected via a path 74 such as a data bus that permits communication among the components of the orchestrator system 14. Each element of the orchestrator system 14 may be partially or completely network-based or cloud-based, and may or may not be located in a single physical location.

The memory 66 may be one or more non-transitory processor-readable medium. The memory 66 may store the application 70 that, when executed by the processor 58, causes the orchestrator system 14 to perform an action such as communicate with or control one or more component of the orchestrator system 14 and/or, via the network 26, with the insurer system 18, the medical system 20, and/or the State system 22. The memory 66 may be one or more memory 66 working together, or independently, to store processor-executable code and may be located locally or remotely, e.g., accessible via the network 26. In some embodiments, the application 70 may be stored as a compiled application file, such as an executable file, for example, or in a structure (or unstructured) format, such as, e.g., in a non-compiled file.

In some embodiments, the memory 66 may be located in the same physical location as the orchestrator system 14, and/or one or more memory 66 may be located remotely from the orchestrator system 14. For example, the memory 66 may be located remotely from the orchestrator system 14 and communicate with the processor 58 via the network 26. Additionally, when more than one memory 66 is used, a first memory 66 may be located in the same physical location as the processor 58, and additional memory 66 may be located in a location physically remote from the processor 58. Additionally, the memory 66 may be implemented as a “cloud” non-transitory processor-readable medium (i.e., one or more memory 66 may be partially or completely based on or accessed using the network 26).

The input device 50 may be capable of receiving information input from the user and/or processor 58, and transmitting such information to other components of the orchestrator system 14 and/or the network 26. The input device 50 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The output device 54 may be capable of outputting information in a form perceivable by the user and/or processor 58. Implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, an olfactory generator, a network interface, combinations thereof, and the like, for example. It is to be understood that in some exemplary embodiments, the input device 50 and the output device 54 may be implemented as a single device, such as, for example, a touchscreen of a computer, a tablet, or a smartphone. It is to be further understood that as used herein the term user is not limited to a human being, and may comprise a computer, a server, a website, a processor, a network interface, a user terminal, a virtual computer, combinations thereof, and/or the like, for example.

The network 26 may permit bi-directional communication of information and/or data between the orchestrator system 14 and one or more of the insurer system 18, the medical system 20, the State system 22, and/or the user system 28. The network 26 may interface with the orchestrator system 14 and the insurer system 18, the medical system 20, the State system 22, and/or the user system 28 in a variety of ways. For example, in some embodiments, the network 26 may interface by optical and/or electronic interfaces, and/or may use a plurality of network topographies and/or protocols including, but not limited to, Ethernet, TCP/IP, circuit switched path, combinations thereof, and/or the like, as described above.

The processor 58 may be implemented as a single processor or multiple processors working together, or independently, to execute the application 70 as described herein. It is to be understood, that in certain embodiments using more than one processor 58, the processors 58 may be located remotely from one another, located in the same location, or comprising a unitary multi-core processor. The processors 58 may be capable of reading and/or executing processor-executable code and/or capable of creating, manipulating, retrieving, altering, and/or storing data structures into the memory 66 such as in the database 72.

Exemplary embodiments of the processor 58 may include, but are not limited to, a digital signal processor (DSP), a central processing unit (CPU), a field programmable gate array (FPGA), a microprocessor, a multi-core processor, an application specific integrated circuit (ASIC), combinations thereof, and/or the like, for example. The processor 58 may be capable of communicating with the memory 66 via the path 74 (e.g., data bus). The processor 58 may be capable of communicating with the input device 50 and/or the output device 54. The processor 58 may include one or more processor 58 working together, or independently, and located locally, or remotely, e.g., accessible via the network 26.

The processor 58 may be further capable of interfacing and/or communicating with the insurer system 18, the medical system 20, the State system 22, and/or the user system 28 via the network 26 using a communication device 108 (FIG. 3). For example, the processor 58 may be capable of communicating via the network 26 by exchanging signals (e.g., analog, digital, optical, and/or the like) via one or more port (e.g., physical, or virtual ports) using a network protocol to provide updated information to the application 70 or the user interface executed on the user system 28.

In one embodiment, the database 72 may be a relational database or a non-relational database. Examples of such databases comprise, DB2®, Microsoft® Access, Microsoft® SQL Server, Oracle®, MySQL, PostgreSQL, MongoDB, Apache Cassandra, and the like. It should be understood that these examples have been provided for the purposes of illustration only and should not be construed as limiting the presently disclosed inventive concepts. The database 72 may be centralized or distributed across multiple systems. In one embodiment, the database 72 may be a centralized database with a distributed backup database, a distributed database with a centralized backup database, a distributed database with a distributed backup database, or a centralized database with a centralized backup database. In one embodiment, the database 72 abides by, or exceeds, the 3-2-1 backup best practices. In one embodiment, each backup database is maintained as a real-time backup database, e.g., the backup database may be a mirror of the database 72.

Referring now to FIG. 3, shown therein is a diagram of an exemplary embodiment of the user system 28 constructed in accordance with the present disclosure. The user system 28 may include one or more device that execute(s) one or more application in a manner described herein. In the illustrated embodiment, the user system 28 is provided with a memory 82 (hereinafter “memory 82”) accessible by one or more processor 86 (hereinafter “processor 86”). The memory 82 may include one or more non-transitory computer-readable medium storing processor-executable code and/or software application(s) 90 (hereinafter “coordination application 90”).

In some embodiments, the user system 28 may comprise the one or more processor 86 working together or independently to execute processor-executable code, such as the coordination application 90, stored on the memory 82. Additionally, the user system 28 may include at least one input device 96 (hereinafter “input device 96”) and at least one output device 100 (hereinafter “output device 100”). Each element of the user system 28 may be partially or completely network-based or cloud-based, and may or may not be located in a single physical location.

The processor 86 may be implemented as a single processor or multiple processors working together, or independently, to execute the coordination application 90 as described herein. It is to be understood, that in certain embodiments using more than one processor 86, the processors 86 may be located remotely from one another, located in the same location, or comprising a unitary multi-core processor. The processors 86 may be capable of reading and/or executing processor-executable code and/or capable of creating, manipulating, retrieving, altering, and/or storing data structures into the memory 82 such as in the database 94.

Exemplary embodiments of the processor 86 may be constructed similar to and in accordance with the processor 58 described above in more detail. The processor 86 may be capable of communicating with the memory 82 via a path 104 (e.g., data bus). The processor 86 may be capable of communicating with the input device 96 and/or the output device 100.

The processor 86 may be further capable of interfacing and/or communicating with the user system 28 via the network 26 using a communication device 108. For example, the processor 86 may be capable of communicating via the network 26 by exchanging signals (e.g., analog, digital, optical, and/or the like) via one or more port (e.g., physical, or virtual ports) using a network protocol to provide updated information to the application 70, the coordination application 90, or the user interface executed on the user system 28.

The memory 82 may store processor-executable code and/or information comprising the coordination application 90. In some embodiments, the coordination application 90 may be stored as a compiled application file, such as an executable file, for example, or in a structure (or unstructured) format, such as, e.g., in a non-compiled file.

The input device 96 of the user system 28 may transmit data to the processor 86 and may be constructed in accordance with or similar to the input device 50 of the orchestrator system 14 described above in more detail. The input device 96 may be located in the same physical location as the processor 86, or located remotely and/or partially or completely network-based. The output device 100 of the user system 28 may transmit information from the processor 86 to the user, and may be similar to the output device 54 of the orchestrator system 14. The output device 100 may be located with the processor 86, or located remotely and/or partially or completely network-based.

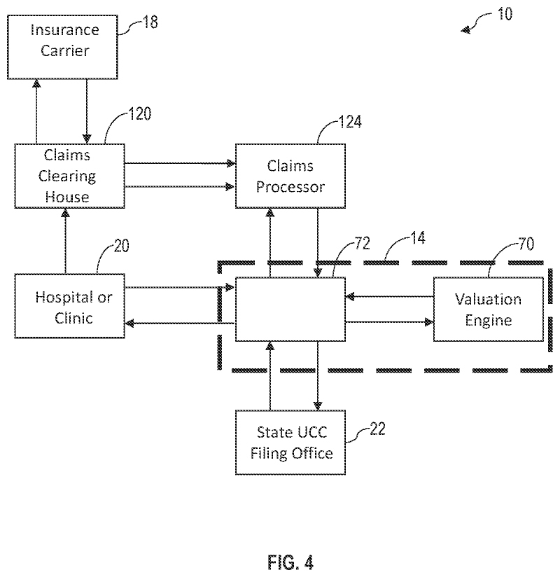

Referring now to FIG. 4, shown therein is a functional block diagram of an exemplary embodiment of the valuation system 10 constructed in accordance with the present disclosure. In one embodiment, the orchestrator system 14 controls and organizes the securitization of medical claims. While the present disclosure references securitization of medical claims, other financial propositions with an embedded promise or a measurable expectation where the embedded promise or expectation is fulfilled over a finite time horizon may be controlled and/or organized by the orchestrator system 14.

Generally, after a service is rendered to a patient in a medical facility, the medical system 20 generates a medical claim (e.g., a bill or statement for services performed) and sends medical claims data to a clearinghouse system 120. Each medical claims data may include one or more claim property, such as a claim identifier, patient information, procedure performed (such as ICD 10 procedure code), procedure date, insurer coding, billing coding, patient name and other biographical information, insurance provider (or destination payer name), claim date, healthcare provider ID, service facility name, attending physician ID, and the like, or some combination thereof. In one embodiment, the medical claims data may comprise a plurality of subclaim data. Each subclaim data may be processed independently as described herein, such as by the procedure performed claim property.

Once the clearinghouse system 120 receives the medical claims data, the clearinghouse system 120 may transmit, via the network 26, the medical claims data to the insurer system 18 as well as a claims processor system 124. In one embodiment, the clearinghouse system 120 may sanitize the medical claims data sent to the claims processor system 124, such as by removing sensitive and security data from the medical claims data. For example, the clearinghouse system 120 may maintain requisite data security and encryption to maintain compliance with HIPAA regulation, and/or other regulations regarding transmission and/or storage of sensitive, personal data.

When the claims processor system 124 receives the sanitized claims data, the claims processor system 124 may transmit the sanitized claims data to the orchestrator system 14. The processor 58 of the orchestrator system 14, executing the application 70, may receive the sanitized claims data from the claims processor system 124 via the network 26 and may store the sanitized claims data in the database 72 in the memory 66. The processor 58 may maintain the sanitized claims data, including the subclaim data, in the database 72 pending real-time valuation.

In one embodiment, the processor 58, executing the application 70, may retrieve a subset of the sanitized claims data, such as one or more subclaim from the plurality of subclaims of one or more medical claim, from the database 72, execute a valuation process to convert the subset of the sanitized claims data into an augmented claim dataset, and store or update the augmented claim dataset in the database 72. In one embodiment, the augmented claim dataset includes the subset of the sanitized claims data as well as one or more securitization parameters such as: an expected reimbursement amount, a standard deviation of reimbursement amount, an expected reimbursement delay (e.g., in days, hours, or other time period), and a standard deviation of reimbursement delay (e.g., in days, hours, or other time period). In one embodiment, the valuation process (as described below) applies one or more securitization parameter to the subset of the sanitized claims data when generating the augmented claim dataset. Each securitization parameter may be a 16-byte data element stored in the memory 66.

In one embodiment, the processor 58, when executing the valuation process, generates, as part of the augmented claim dataset, a claim valuation for each subclaim of the subset of the sanitized claims data, for example, as based on the claim identifier. In other words, the augmented claim dataset includes at least a claim valuation and a claim identifier. The claim valuation may be, for example, a claim financing value (such as the one or more securitization parameters) and (optionally) a financeable flag, indicative of whether a particular sanitized claim data has a financeable value.

In one embodiment, after the processor 58 stores and/or updates the augmented claim dataset in the database 72, the processor 58 may validate and/or confirm that the augmented claim dataset has been successfully stored and/or updated. For example, the processor 58 may compare the augmented claim dataset that was stored in the database 72 against the augmented claim dataset that was provided to the database 72 or the processor 58 may receive a confirmation notification from the database 72 that the augmented claim dataset was successfully stored/updated in the database 72.

In one embodiment, the processor 58 may generate a lien on a plurality of medical claims based on the claim valuation for each subclaim of the augmented claim dataset, for example, as described in pool creation process 200 below. The processor 58 may select one or more subclaim and corresponding claim identifier (e.g., a lien claims set) from the augmented claim dataset where the one or more subclaim has a claim valuation greater than $0 or where the claim valuation is the financeable flag indicative of the augmented claim having a financeable value.

The processor 58, executing application 70, may generate a lien request for the lien claims set and transmit the lien request to the State system 22. In one embodiment, the State system 22 corresponds to a computer-accessible endpoint for a government entity having the authority to record the lien. For example, the State system 22 may correspond to a Secretary of State's office for a particular State (in the United States of America) in which the medical facility associated with the medical claim is located, domiciled, organized, and/or the like. In one embodiment, the lien request may include lien data as required to file a financing statement (e.g., place a lien) against the plurality of medical claims, such as required by the Uniform Commercial Code, for example, for a UCC-1 statement, and/or required by a particular State. For example, the lien data may include at least part of the augmented claim dataset, such as, data to describe and/or identify the plurality of medical claims unambiguously and/or uniquely.

In one embodiment, the lien request may be a computer file or service having a predetermined data format, such as an object-oriented data format. Non-limiting predetermined data formats may include, for example, an XML format, an X12 format, a YAML format, a JSON format, and/or the like. For example, if the lien request is a computer file, the predetermined data format may be an XML format.

In one embodiment, transmitting the lien request to the State system 22 may include the processor 58 accessing the communication device 62 and sending one or more communication to the State system 22 via the network 26. For example, the State system 22 may provide an application programming interface (API) operable to receive one or more communication via the network 26 and expose one or more function or method accessible to the processor 58 executing the application 70. The API may be a set of routines, protocols, functions, and/or methods for interacting with the State system 22 exposed as an API endpoint. The API may express a software component in terms of the software component's operations, inputs, outputs, and underlying types. The API may implement one or more of an HTTP request method, such as GET or POST.

In one embodiment, the API defines functionalities that are independent of respective implementations, which allows definitions and implementations to vary without compromising each other (e.g., programmatically decoupling function definitions and/or headings from function implementations). In one embodiment, the API is in the form of a library that includes specifications for routines, data structures, object classes, and variables. In other embodiments, notably SOAP and REST services, the API is a specification of remote calls exposed to API consumers. The API specification can take many forms, including an International 7 Standard, such as POSIX, vendor documentation, such as the Microsoft Windows API, a high-performance Remote Procedure Call (such as gRPC), or the libraries of a programming language, e.g., Standard Template Library in C++ or Java API. In one embodiment, the API may access one or more database, service, authentication, and/or integration provider, such as, for example, Firebase. In one embodiment, the API may use a message broker provider or message queueing system to manage one or more API call. For example, the API may utilize RabbitMQ (VMware, Inc., Palo Alto, CA), MQTT (Oasis MQTT 5 Specification), or gRPC.

In one embodiment, the processor 58 may transfer the lien request, via the network 26, as a HTML request, or as a file attachment or insertion into the HTML request. For example, the processor 58 may transfer the lien request as an XML-based HTTP(S) POST call to the State system 22.

In one embodiment, the lien request may include one or more of a request to file a financing statement (e.g., place a lien) on the plurality of medical claims, a request to modify one or more lien, and a request to remove one or more lien.

In one embodiment, the processor 58 may receive, via the network 26, a lien response from the State system 22 after transmitting the lien request. The lien response may have a predetermined data structure, as described above. For example, the lien response may have a predetermined XML data structure.

In one embodiment, the processor 58 stores the lien response in the memory 66, such as in the database 72. For example, the processor 58 may store the lien response in the database 72. In another embodiment, the processor 58 stores the lien response in the database 72 and associates the lien response with one or more medical claim of the plurality of medical claims, such as by associating the lien response with one or more claim identifier for each medical claim processed in the lien request and/or lien response.

In one embodiment, the processor 58 may further generate one or more eligibility communication and transmit the one or more eligibility communication to the claims processor system 124 via the network 26. The processor 58 may generate the eligibility communication as a network communication (such as an HTML request or as a file attachment, for example) for each medical claim in the lien request for which the lien request was approved in the lien response. In other embodiments, the processor 58 may aggregate all medical claims having a lien request approved in the lien response into an eligibility communication. In one embodiment, the eligibility request may have a predetermined data structure, as described above, and may include the processor 58 transmitting one or more communication via the network 26 and/or the processor 58 communicating with one or more API as detailed above.

The claims processor system 124 may transmit an eligibility communication response indicative of an acknowledgement that the one or more medical claim has been processed by the claims processor system 124. For example, the acknowledgement may include an indication that the one or more medical claim of the plurality of medical claims has been tagged and included in a status report the claims processor system 124 requests and/or receives from the insurer system 18 and/or the clearinghouse system 120. In one embodiment, the processor 58 may store one or more eligibility indicator for each medical claim associated in the database 70.

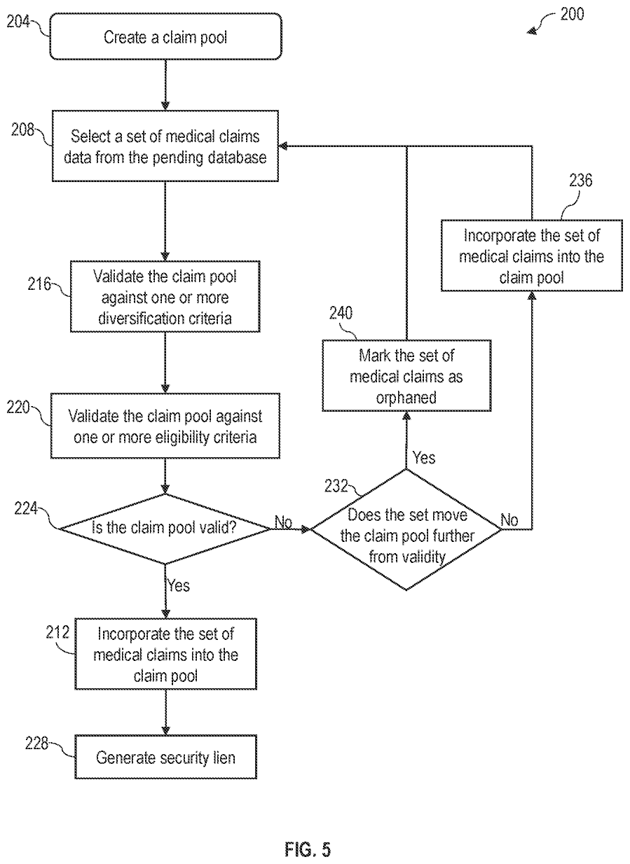

In one embodiment, the processor 58 monitors the database 72 for at least a total claim valuation and a total claim count. Once the total claim valuation meets or exceeds a valuation pool threshold and/or the total claim count meets or exceeds a claim count pool threshold, the processor 58 may execute a pool creation process 200 (described below and shown in FIG. 5) to create a claim pool and offer commercial paper notes or other short-term securities secured by the claim pool (i.e., a selected subset of the plurality of medical claims in the database 72), to buyers via the user interface of the user system 28. In one embodiment, the claim pool is geographically bound such that all medical claims in the claim pool originate from the same State.

In one embodiment, the insurer system 18 may pay a particular medical claim (by posting payment to a lockbox account associated with the medical facility that made the particular medical claim) and send an explanation of benefits to the clearinghouse system 120, which, in turn, the clearinghouse system 120 forwards the explanation of benefits to the medical system 20 as well as sanitizes the explanation of benefits (as described above) and transmits the sanitized explanation of benefits to the claims processor system 124. The sanitized explanation of benefits may contain information such as the medical claims data, without personally identifiable information, as well as a reimbursement amount for each medical claims in the medical claims data. As used herein, the lockbox account may be a bank account (such as a trust account) operated by a banking institution on behalf of a medical facility/hospital system. The lockbox account may include a bank-operated mailing address to which a company directed payors to send their payments. The bank may open the incoming mail, deposit received funds in the bank account, and scans the payments and any remittance information.

In one embodiment, the processor 58 of the orchestrator system 14 may receive the sanitized explanation of benefits from the claims processor system 124 and store the sanitized explanation of benefits in the database 72, and may identify one or more claim pool associated with the medical claims/subclaims in the explanation of benefits and a payment amount for each medical claim/subclaim.

In one embodiment, the processor 58 accesses the lockbox account via the network 26, and transfers claims funds stored in the lock-box account to a particular collection account at a depository institution. The processor 58, upon confirmation that the claims funds have been successfully transferred to the particular collection account may update a particular sanitized explanation of benefits stored in the database 72 with a paid indication that the particular sanitized explanation of benefits has been paid. The processor 58 may then retrieve the lien response corresponding to the particular sanitized explanation of benefits from the memory 66, such as by selecting a lien request from the database 72 associated with the same claim identifier as the particular sanitized explanation of benefits. The processor 58 may then use the lien response to generate a second lien request, having the predetermined data structure, indicative of a request to remove the particular lien. The processor 58 may then send the second lien request to the State system 22 to cause the State system 22 to remove the lien on the medical claims corresponding to the particular sanitized explanation of benefits, for example, by filing a financial statement amendment.

In one embodiment, the processor 58 performs the claims funds transfer periodically. For example, the processor 58 may perform the transfer every day, every hour, every half hour, every minute, or the like. In one embodiment, the processor 58 may perform the transfer every day of the year, whereas in other embodiments, the processor 58 may perform the transfer on weekdays, or on weekdays that are not holidays, such as bank holidays.

In one embodiment, the processor 58, executing the application 70, may execute a revaluation process. The processor 58 may execute the revaluation process periodically. The revaluation process may include recomputing the one or more securitization parameter for one or more subclaim in the database 72.

In one embodiment, the processor 58, executing the revaluation process, may analyze the database 72 to determine one or more modification to the one or more securitization parameters for each type of medical claim, for example, as based on the medical claim code, the medical facility, and the insurance provider.

In one embodiment, the processor 58 executing the revaluation process may update an expected claim valuation in the database 72 for each subclaim in the explanation of benefits. In one embodiment, the database 72 may store a claim valuation for each combination of properties of each medical claim in the medical claims data. For example, the database 72 may store a first claim valuation for a first medical claim in the medical claims data having a first procedure code, a first healthcare provider ID, a first insurance provider, and a first attending physician and store a second claim valuation for a second medical claim in the medical claims data having the first procedure code, a second insurance provider, and the first attending physician. In this example, two medical claims having the same procedure code may have different claim valuations when the only different between the first medical claims and the second medical claim is the insurance provider.

In one embodiment, the processor 58 executing the revaluation process, may adjust the expected claim valuation in the database 72 for each subclaim in the explanation of benefits. For example, the processor 58 may increase the expected claim valuation in the database 72 for a particular subclaim based on the one or more claim properties in the explanation of benefits when the reimbursement amount for the claim in the explanation of benefits is greater than the expected claim valuation or may decrease the expected claim valuation in the database 72 for a particular subclaim based on the one or more claim properties in the explanation of benefits when the reimbursement amount for the claim in the explanation of benefits is less than the expected claim valuation.

In other embodiments, the database 72 may store a base claim valuation for a type of medical claim, such as based on the procedure code and one or more multiplier (or attunement value) for each value of one or more property of each medical claim in the medical claims data, and (optionally)_an offset value. In other words, the processor 58 may calculate the claim valuation for a particular medical claim by selecting the base claim valuation for a medical claim having a particular procedure code and adjusting the base claim valuation based on the multiplier for each of the claim properties associated with the medical claim. For example, the processor 58 may multiply the base claim valuation associated with a medical claim by a first multiplier associated with a first insurance provider and a first attending physician to generate the claim valuation for the medical claim.

In one embodiment, the processor 58 executing the revaluation process, may adjust the one or more multiplier (or offset value) of one or more claim property of each medical claim in the explanation of benefits. For example, the processor 58 may increase the base claim valuation and/or the one or more multiplier or offset if the reimbursement amount in the explanation of benefits associated with a medical claim is greater than an expected claim valuation for the medical claim or may decrease the base claim valuation and/or the one or more multiplier or offset if the reimbursement amount in the explanation of benefits associated with a medical claim is less than an expected claim valuation for the medical claim.

In one embodiment, the processor 58, executing the revaluation process, may generate one or more notification if a valuation cannot be determined for one or more particular medical claim or medical claim type. The one or more notification may include, for example, an SMS message, an MMS message, a text message, an instant message, an email message, a smartphone notification and/or the like, or some combination thereof.

Referring now to FIG. 5, shown therein is a process flow diagram of an exemplary embodiment of the pool creation process 200 constructed in accordance with the present disclosure. The pool creation process 200 generally comprises the steps of: creating a claim pool (step 204); selecting a set of medical claims data from the database (step 208); validating the claim pool against one or more diversification criteria (step 216); validating the claim pool against one or more eligibility criteria (step 220); if the claim pool is valid (decision 224) then incorporating the set of medical claims into the claim pool (step 212) and generating the security (step 228). Otherwise, if the set of medical claims data moves the claim pool further from validity (decision 232) proceed to marking the set of medical claims data as orphaned (step 240). If the set of medical claims data does not move the claim pool further from validity (decision 232), proceed to incorporating the set of medical claims into the claim pool (step 236). After both step 236 and step 240, proceed back to selecting the set of medical claims data from the database (step 208). In one embodiment, the pool creation process 200 is implemented as a software such as in the application 70 stored in the memory 66.

In one embodiment, the processor 58 creates the claim pool (step 204) by instantiating, such as in the memory 66, a data object operable to store one or more medical claims data selected from the database 72 stored in the memory 66. In one embodiment, the processor 58 creates a claim pool for each medical claims data in a particular geographic region, such as a State. Each claim pool may have a pool identifier to enable the processor 58 to identify a specific claim pool in the memory 66.

In one embodiment, the processor 58 selects the provisional set of medical claims data from the database (step 208) based on a first in, first out (FIFO) policy. For example, each medical claim data in the database 72 has the claim date, and is prioritized based on the oldest medical claims data (e.g., medical claims data having the claim date furthest in the past) are selected for the claim pool. In one embodiment, selecting the provisional set of medical claims data from the database (step 208) may include selecting medical claims data that do not include a finalized tag and/or a pool identifier.

In one embodiment, if the claim pool is empty and/or if the database 72 does not include any claims that are not indicated as orphaned claims, the processor 58 selects the provisional set of medical claims data from the database (step 208) where the medical claims data include an orphaned identifier. In one embodiment, if the claim pool is not empty and/or if the database 72 does include claims that are indicated as orphaned claims, the processor 58 selects the provisional set of medical claims data from the database (step 208) where the medical claims data do not include the orphaned identifier.

In one embodiment, the processor 58 selects the provisional set of medical claims data from the database (step 208) by selecting a predetermined quantity of medical claims data from the database as the provisional set of medical claims data. The predetermined quantity may be a number of medical claims data to include into the claim pool per iteration of the claim pool creation process 200. For example, the predetermined quantity may be, for example, between 1,000 and 10,000 medical claims data, and is preferably 5,000 medical claims data. In one embodiment, the provisional set of medical claims data may include a single medical claims datum.

In one embodiment, the processor 58 may create the claim pool from a subset of the plurality of medical claims data in the database 72. The processor 58 may select the subset such that the medical claims data in the subset meet the pre-determined set of diversification and eligibility criteria or set of provided covenants as described below. Further, the processor 58 may select the pre-determined set of diversification and eligibility criteria such that no excessive concentrations and other conditions that might affect the default probability of a security backed by the medical claims in the provisional set of medical claims data will be present, and such that the provisional set of medical claims data is a minimum, or nearly minimum, quantity of medical claims data of the plurality of medical claims data in the database 72, meeting the criteria, such as the pre-determined set of diversification criteria and eligibility criteria.

In one embodiment, the processor 58 validates the claim pool against one or more diversification criteria (step 216) by determining whether a total claim valuation of the medical claims data in the claim pool and/or the provisional set of medical claims data from the database 72 meets or exceeds a valuation pool threshold and/or a total claim count meets or exceeds a claim count pool threshold. Each diversification criteria of the one or more diversification criteria may further include a criteria priority.

In one embodiment, the valuation pool threshold may be a minimum pool balance of the total claim valuation for the medical claims data in the claim pool. For example, the processor 58 may calculate the total claim valuation buy calculating the algebraic sum of expected claim-reimbursement amounts for each medical claim data in the claim pool. The expected claim-reimbursement amount for a medical claim data may be an undiscounted reimbursable amount. In one embodiment, the minimum pool balance is a predetermined minimum balance, however, in other embodiments, the processor 58 may receive the minimum pool balance from the user via the user system 28.

In one embodiment, the claim count pool threshold is a predetermined minimum claim count, however, in other embodiments, the processor 58 may receive the minimum claim count from the user via the user system 28. In one embodiment, the claim count pool threshold includes both a minimum claim count and a maximum claim count such that the total claim count of the medical claims data in the claim pool and/or in the provisional set of medical claims data are between the minimum claim count and the maximum claim count.

In one embodiment, the processor 58 validates the claim pool and/or the provisional set of medical claims data against the one or more eligibility criteria (step 220) including validating the claim pool and/or the provisional set of medical claims data from the database 72 against one or more provided covenant.

In one embodiment, the processor 58 may receive one or more provided covenant (or custom criteria), e.g., from the user via the user system 28, and may store the one or more provided covenant as a set of provided covenants in the memory 66. Each covenant of the set of provided covenants may by a statistical covenant for validation of a particular claim pool and/or the provisional set of medical claims data from the database 72. Exemplary covenants/criteria may include a medical specialty covenant, an insurance-payor covenant, a healthcare provider covenant, an ICD10 procedure code covenant, claims value covenant, a geographical diversification covenant, and the like, or some combination thereof. Each covenant or criteria may include at least one covenant, or criteria, threshold and may include an upper covenant, or criteria, threshold and a lower covenant, or criteria, threshold. In one embodiment, the processor 58 validates the claim pool and the provisional set of medical claims data from the database 72 independently of each other as well as combined with each other.

In one embodiment, the processor 58 may receive one or more criteria communication, via the network 26, from a user operating the user system 28. The one or more criteria communication may include one or more custom eligibility criteria. In one embodiment, the one or more custom eligibility criteria may further include one or more eligibility threshold (such as a minimum eligibility threshold and a maximum eligibility threshold) and may also include a criterion priority. The processor 58 may further validate the provisional set of medical claims data such that the medical claims data in the provisional set meet both the pre-determined set of diversification criteria and eligibility criteria as well as the custom eligibility criteria. In some embodiments, based on the criteria priority, the custom criteria may supersede the pre-determined set of diversification and eligibility criteria (e.g., a conflict between the custom criteria and the pre-determined set of diversification and eligibility criteria is resolved in favor of the custom criteria), the pre-determined set of diversification and eligibility criteria may supersede the custom criteria, or a combination thereof (e.g., a conflict between a first one of the custom criteria may supersede a first one of the pre-determined set of diversification and eligibility criteria, while a conflict between a second one of the pre-determined set of diversification and eligibility criteria may supersede a second one of the custom criteria).

In one embodiment, the processor 58 determines if the claim pool is valid (decision 224) based on a validation at step 216 and at step 220. For example, the processor 58 may determine that the claim pool is valid (decision 224) only if both the claim pool is valid against the one or more diversification criteria (in step 216) and the claim pool is valid against the one or more eligibility criteria (in step 220).

In one embodiment, the processor 58 determines if the claim pool is valid (decision 224), and, if the claim pool is valid, then the processor 58 incorporates the set of medical claims into the claim pool (step 212) and generates the security (step 228), for example, by adding a pool indicator to the set of medical claims data in the database 72 and adding a finalized tag to the medical claims data in the claim pool. The pool indicator may be, for example, a claim pool ID. The processor 58 may determine that the claim pool is valid if the claim pool and the set of medical claims data are valid at step 216 and step 220.

In one embodiment, the processor 58 determines if the claim pool is valid (decision 224), and, if the claim pool is not valid, then the processor 58 determines whether incorporating the provisional set of medical claims data into the claim pool does not move the claim pool further from validity (step 232). If the processor 58 determines that incorporating the provisional set of medical claims data into the claim pool does not move the claim pool further from validity, then the processor 58 may incorporate the provisional set of medical claims data into the claim pool (step 236). Step 236 may be conducted in accordance with step 212 described above. The processor 58 may determine that incorporating the provisional set of medical claims data into the claim pool does not move the claim pool further from validity by comparing how far the claim pool without the provisional set of medical claims data is from one or more criteria threshold (pre-inclusion difference) to how far the claim pool with the provisional set of medical claims data included is from the one or more criteria threshold (inclusion difference). If the pre-inclusion difference is greater than the inclusion difference, then the processor 58 may determine that incorporating the provisional set of medical claims data into the claim pool does not move the claim pool further from validity.

In one embodiment, the processor 58 determines if the claim pool is valid (decision 224), and, if the claim pool is not valid, then the processor 58 may modify a particular criteria threshold of the one or more eligibility criteria and/or the one or more diversification criteria, based on the criteria priority, such that the particular criteria threshold is less restrictive. In one embodiment, the particular criteria may be less restrictive if a range between an upper criteria threshold and a lower criteria threshold is greater and/or wider. For example, the processor 58 may modify a first particular criteria having a first criteria priority before the processor 58 modifies a second particular criteria having a second criteria priority, if the first criteria priority if lesser than the second criteria priority. If the processor 58 modifies any criteria, the processor 58 may transmit one or more notification to the user system 28 indicative of the modification.

In one embodiment, the processor 58 determines if the claim pool is valid (decision 224), and, if the claim pool is not valid, then the processor 58 determines whether incorporating the provisional set of medical claims data into the claim pool does not move the claim pool further from validity (step 232). If the processor 58 determines that incorporating the provisional set of medical claims data into the claim pool does move the claim pool further from validity, the processor 58 may mark the provisional set of medical claims data as orphaned (step 240) in the database 72. Marking the medical claims data as orphaned (step 240) may include, for example, associating the orphaned indicator in the database 72 for each medical claim data (e.g., record) in the provisional set of medical claims data. In one embodiment, the orphaned indicator may be a timestamp. In other embodiments, the orphaned indicator may be an orphaned flag or an orphaned tag.

In one embodiment, the processor 58 determines if the claim pool is valid (decision 224), and, if the claim pool is not valid, then the processor 58 increases an iteration counter. In one embodiment, if the iteration counter reaches or exceed an iteration threshold, the processor 58 may transmit one or more notification to the user system 28 indicative of the iteration counter and/or a failure of the pool creation process 200 to generate the claim pool. The one or more notification may further include an indication of which particular criteria fails to validate and/or an indication of the medical claims data, and/or provisional set of medical claims data, which failed to validate.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A system, comprising:
a processor; and
a memory comprising a non-transitory processor-readable medium storing processor-executable instructions that when executed by the processor, causes the processor to:
create a claim pool;
receive a set of medical claims data from a database stored in the memory, each medical claims data comprising at least a claim identifier, a procedure code, and a claim date;
validate the claim pool against one or more diversification criteria;
validate the claim pool against one or more eligibility criteria;
if the claim pool is valid, then incorporate the set of medical claims data into the claim pool and generate a security; and
if the claim pool is not valid, mark at least a portion of the set of medical claims data as orphaned if the set of medical claims data moves the claim pool further from validity or incorporate the set of medical claims data into the claim pool if the set of medical claims data does not move the claim pool further from validity and return to receive the set of medical claims data.

2. The system of claim 1, wherein the memory includes executable instructions that when executed, further cause the processor to:
receive the set of medical claims data by selecting the set of medical claims data from the database stored in the memory.

3. The system of claim 1, wherein the memory includes executable instructions that when executed, further cause the processor to:
receive the set of medical claims data in real-time from a claims processor system.

4. The system of claim 1, wherein marking at least the portion of the set of medical claims data as orphaned includes associating an orphaned indicator for particular records of the set of medical claims data in the database based in part on the claim identifier.

5. The system of claim 4, wherein receiving the set of medical claims data from the database includes excluding from the set of medical claims data the particular records having the orphaned indicator.

6. The system of claim 4, wherein the orphaned indicator is a timestamp.

7. The system of claim 1, wherein marking at least the portion of the set of medical claims data as orphaned includes marking particular records within the database with a time stamp, and wherein receiving the set of medical claims data from the database includes excluding from the set of medical claims data particular records having the time stamp.

8. The system of claim 1, wherein the set of medical claims data includes all claims generated by a particular healthcare institution within a predetermined time period.

9. The system of claim 1, wherein the one or more diversification criteria include one or more of a valuation pool threshold and a claim count pool threshold; wherein the valuation pool threshold is a minimum pool balance of the set of medical claims data and the claim count pool threshold is a minimum claim count of claims in the set of medical claims data.

10. The system of claim 9, wherein validating the claim pool against one or more diversification criteria includes calculating a total expected claim-reimbursement amount for the set of medical claims data based at least in part on the procedure code of each medical claim data and comparing the total expected claim-reimbursement amount against the valuation pool threshold.

11. The system of claim 1, wherein the one or more eligibility criteria is a minimum eligibility threshold and a maximum eligibility threshold.

12. The system of claim 1, wherein the one or more eligibility criteria is one or more of a medical specialty ratio threshold, an insurer ratio threshold, a provider ratio threshold, a procedure code ratio, and a geographical diversification threshold.

13. The system of claim 1, wherein the memory includes executable instructions that when executed, further cause the processor to:
receive one or more criteria communication comprising one or more custom criteria; and
validate the claim pool against the one or more custom criteria.

14. The system of claim 13, wherein the one or more criteria communication further comprises a criteria priority associated with each of the one or more custom criteria, the memory further including executable instructions that when executed, further cause the processor to:
adjust a first custom criteria of the one or more custom criteria having a first criteria priority prior to adjusting a second custom criteria of the one or more custom criteria having a second criteria priority when the second criteria priority is greater than the first criteria priority.

15. An orchestrator system, comprising:
a processor; and
a memory comprising a non-transitory processor-readable medium storing processor-executable instructions that when executed by the processor, causes the processor to:
receive sanitized claims data from a claims processor system, the sanitized claims data including one or more medical claims data corresponding to one or more medical claim and having a plurality of claim properties comprising at least a claim identifier, a procedure date, a procedure performed, a healthcare provider ID, a geographic area, an insurer ID, and a claim date;
augment the sanitized claims data to include a claim valuation for each of the one or more medical claims data based on the plurality of claim properties and to include one or more securitization parameters;
create a claim pool comprising a provisional set of the one or more medical claims data;
generate a lien request for each medical claim corresponding to the medical claims data in the claim pool, the lien request being indicative of a financing statement;
transmit the lien request to a State system corresponding to the geographic area;
receive a sanitized explanation of benefits associated with an insurer having the insurer ID, the sanitized explanation of benefits including at least the healthcare provider ID, one or more claim identifier, a payment date, and a payment amount for each claim identifier; and
transmit a transfer request to a third-party banking system having a lockbox account corresponding to the healthcare provider ID, the transfer request being a request to transfer funds based on the payment amount for each claim identifier in the explanation of benefits.

16. The orchestrator system of claim 15, wherein the lien request is a first lien request and the memory includes executable instructions that when executed, further cause the processor to:
generate a second lien request when funds corresponding to all claim identifiers for all medical claims data in the claim pool have been received, the second lien request being indicative of an amendment to the financing statement.

17. The orchestrator system of claim 16, wherein generating the second lien request may be triggered by receiving one or more communication from a user device associated with a user.

18. The orchestrator system of claim 15, wherein the one or more securitization parameters is one or more eligibility criteria or one or more diversification criteria.

19. The orchestrator system of claim 15, wherein the memory includes executable instructions that when executed, further cause the processor to:
associate the procedure performed with the insurer ID, a healthcare provider ID, the payment date, and the payment amount based on each claim identifier of the sanitized explanation of benefits and the one or more medical claims data, the association being a paid procedure data.

20. The orchestrator system of claim 19, wherein augmenting the sanitized claims data to include the claim valuation further includes:
selecting a paid procedure data for each medical claims data based at least on corresponding the procedure performed of the sanitized claims data to the paid procedure data; and
providing the payment amount of the selected paid procedure data as the claim valuation; and
wherein the selected paid procedure data is a recent paid procedure data based at least in part on one of the payment date and the procedure date.
